(19) United States
(12) Patent Application Publication
(10) Pub. No.: US 2015/0140357 A1
(43) Pub. Date: May 21, 2015

(54) Layer For An Electrical Contact Element, Layer System And Method For Producing A Layer

(71) Applicant: TYCO ELECTRONICS SERVICES GMBH, Bensheim (DE)

(72) Inventors: Helge Schmidt, Speyer (DE); Stefan Thoss, Zwingenberg (DE)

(73) Assignee: TYCO ELECTRONICS AMP GMBH, Bensheim (DE)

(21) Appl. No.: 14/609,873

(22) Filed: Jan. 30, 2015

Related U.S. Application Data
(63) Continuation of application No. PCT/EP2013/065606, filed on Jul. 24, 2013.

(30) Foreign Application Priority Data
Jul. 31, 2012 (DE) 10 2012 213 505.7

(51) Int. Cl. H01B 1/02; C22C 12/00; C25D 7/00

(52) U.S. Cl. CPC H01B 1/026; H01B 1/02; C25D 7/00; C22C 12/00
USPC 428/642; 205/261; 205/122; 420/577; 420/580

(57) ABSTRACT

A contact layer for an electrical contact is disclosed having bismuth and being tin-free.

### CROSS-REFERENCE TO RELATED APPLICATION

This application is a continuation of PCT International Application No. PCT/EP2013/065606 filed Jul. 24, 2013, which claims priority under 35 U.S.C. §119(a)-(d) to German Patent Application 10 2012 213 505.7 filed Jul. 31, 2012.

### FIELD OF THE INVENTION

The invention generally relates to an electrically conductive layer for an electrical contact element, and more specifically, electrically conductive layer for an electrical contact element that resists filament formation.

### BACKGROUND

An electrical contact element serves to produce an electrical connection through the use of a contact element. The contact element is in mechanical and electrical contact with a complimentary contact element. A more or less strong mechanical pressure is thereby often also applied to the contact element, and especially to a surface thereof. The contact element is often connected to the complimentary contact element for long period of time, such that the applied contact pressure exists in most cases over long periods of time. For example, a pressing contact can apply a contact pressure for a long period of time to the complimentary contact element, subjecting both contacts to a high level of mechanical stress. The mechanical stress can be reduced through the use of a resilient reinforced contact surface, leading to a more stable longer-term loading environment.

In order to improve the properties of the connection, and in order to ensure a stable connection for many connection cycles, the contact element is generally coated. Such a coating may, for instance, lower the transition resistance, have increased wear-resistance, or delay or prevent a chemical change such as oxidation of a substrate located below the layer. Since the crystal structures of the substrate and the layer deviate from each other to a greater or lesser extent, the presence of a layer alone can already lead to internal mechanical tensions in the layer. Depending on the coating method, differently sized regions of the layer material with different properties, such as different orientations or crystallisation forms, may further occur. This often leads to an increase of the internal tensions in the layer.

Even without external mechanical pressure, the layer may already be subjected to internal mechanical pressure. Common materials used in the layer often include tin, which has been observed to promote pronounced growth of hair-like or needle-like structures from the layers. These structures are commonly referred to as filaments or whiskers. These whiskers can become very long over time and contact other electrical components, with the result that a short-circuit occurs, or break off and bring about a short-circuit at another location.

As such, a composition that eliminates the use of tin, both as a primary material or as an alloy partner, for forming contact layers in order to prevent the growth of whiskers.

### SUMMARY

A contact layer for an electrical contact has bismuth and is tin-free.

### BRIEF DESCRIPTION OF THE DRAWINGS

The invention will now be described by way of example, with reference to the accompanying Figures, of which:

FIG. 1 is a schematic sectioned view of a contact layer on a substrate;

FIG. 2 is a schematic sectioned view of the contact layer, together with an intermediate layer and a substrate;

FIG. 3 is a schematic cross-section of a contact element having the contact layer;

FIG. 4 is a schematic cross-section of a contact element having a contact layer system, and a complementary contact element;

FIG. 5 is a schematic cross-section of a pressing contact element having the contact layer;

FIG. 6 is a schematic cross-section of a contact layer system;

FIG. 7 is a schematic graph of an energy dispersive X-ray spectroscopy (EDX) analysis of a galvanically produced bismuth layer.

### DETAILED DESCRIPTION OF THE EMBODIMENT(S)

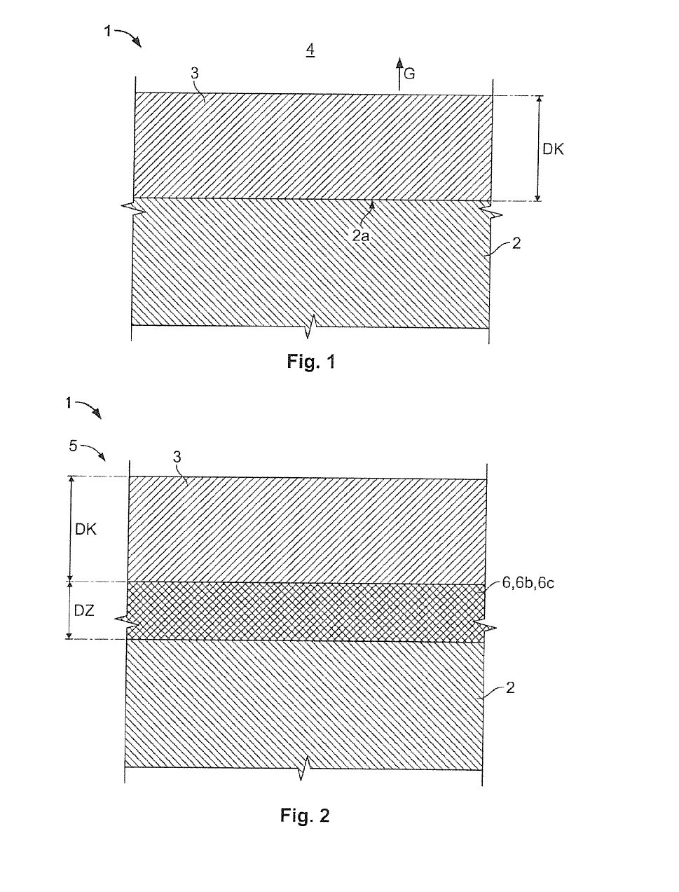

In an embodiment of FIG. 1, a contact element 1 has a substrate 2 and a contact layer 3 positioned on the substrate 2. The contact layer 3 is positioned between the substrate 2 and an environment 4, so that the contact layer shields the environment 4 and the substrate 2 from each other. The contact layer 3 serves to produce a contact surface for contacting with a complementary contact element (not shown).

The contact layer 3 applied to the substrate 2 by electroplating, growing from the surface 2a of the substrate 2 outwards in the growth direction G until it had reached a thickness DK. Once the contact layer 3 reached the desired thickness DK, the growing operation was suspended. In an embodiment, the thickness DK of the contact layer 3 is between 1 μm and 10 μm. In other embodiments, the thickness DK of the contact layer 3 thickness is greater than 10 μm. In another embodiment, the thickness DK of the contact layer 3 is less than 1 μm.

In an embodiment, the contact layer 3 contains bismuth, but no tin, and may be a pure bismuth layer. However, the contact layer 3 may also contain other elements, such that the bismuth proportion is reduced. In an embodiment, a bismuth proportion of >10% may be sufficient to exclude undesirable whisker formation. In an embodiment, the contact layer 3 includes 50% or more of bismuth. In another embodiment, the contact layer 3 includes 90% or more of bismuth. In an embodiment, the contact layer 3 includes substantially pure bismuth having only common trace impurities. One of ordinary skill in the art would appreciate that the percentages in each embodiment, as well as in the remainder of the present application, relate to the percentages of mass. With higher proportions of bismuth, the properties of the layer may be primarily determined by the bismuth. The crystal structure, the morphological, electrical, physical and/or chemical properties are mentioned as such properties purely by way of example. In contact layers, the electrical conductivity and the abrasion resistance are of prime importance.

In an exemplary embodiment, the contact layer 3 is positioned directly on a copper substrate 2. Specifically, no intermediate layer is positioned between the substrate 2 and contact layer 3. The contact layer 3 is applied directly to the copper substrate 2, which would not be possible using conventional contact layers, such as tin layers, since diffusion of the copper atoms into the tin layer would take place, generating a negative influence on the properties of the contact layer 3. Consequently, with the contact layer 3, such an intermediate or diffusion barrier layer may be dispensed with. In an embodiment, a nickel layer may optionally be positioned between the contact layer 3 and the copper substrate 2.

In an embodiment of FIG. 1, the substrate 2 is at least completely covered over the surface area by the contact layer 3 which, owing to the diamagnetic properties of the bismuth, can produce a shielding effect. Examples of the contact element 1 may include a pin contact having a square cross-section.

In an embodiment (not shown), the contact layer 3 extends circumferentially around the cross-section so that the contact layer 3 surrounds the substrate 2 in a tube-like manner. Owing to the diamagnetic properties of bismuth, a waveguide which conducts specific frequencies or a specific frequency range can be produced with minimal material loss.

In an embodiment of FIG. 2, a layering system 5 has the contact layer 3, an intermediate layer 6 and the substrate 2. The intermediate layer 6 is positioned on the substrate 2, and the contact layer 3 is positioned on the intermediate layer 6. The intermediate layer 6 may influence the transition resistance between the substrate 2 and the intermediate layer 6 in a desired manner. In particular, the intermediate layer 6 may lower the transition resistance so that the electrical conductivity of the entire system is low.

The intermediate layer 6 may also act as an intermediate layer 6b when growth of the contact layer 3 on the substrate 2 is not possible without the presence of the intermediate layer 6. Such an intermediate layer 6b may therefore be connected on a first surface to the substrate 2 and on an opposite second surface to the contact layer 3. The intermediate layer 6 may further include lattice constants between the individual atoms, which is between the values of the lattice constants of the substrate 2 and the lattice constants of the contact layer 3. An internal mechanical pressure or tension and/or the increased occurrence of defects, as would be the case with direct application of the contact layer 3 to the substrate 2, can thereby be prevented.

In an embodiment, the intermediate layer 6 may act as a diffusion barrier layer 6c which prevents diffusion of components of the substrate 2 into the contact layer 3 or vice-versa.

The thickness DZ of the intermediate layer 6 and the thickness DK of the contact layer 3 can be selected to be of different sizes depending on the application. For example, the intermediate layer 6 may be a relatively smaller thickness DZ, while the thickness DK of the contact layer 3 may be relatively large. Conversely, in another embodiment, the thickness DK of the contact layer 3 is relatively small and the thickness DZ of the intermediate layer 6 is relatively large.

In an embodiment, the intermediate layer 6 may also be an alloy layer which comprises a combination of the components of the substrate 2 and the contact layer 3. Such a combination may be either directly or indirectly formed.

As with the above described embodiments, the contact layer 3, in addition to bismuth, may also contain other materials, in particular other elemental materials. For example, the contact layer 3 may include zinc, indium, antimony, copper, nickel, silver, gold, palladium and/or ruthenium, the proportions of which can be varied, depending on the application and desired properties to be achieved. Bismuth remains the determining element for the properties, forming the principle component of the alloy layer, such that the percentage by mass of bismuth is larger than the percentage by mass of any other single element. Optionally, lead may also be added to the contact layer 3 alloy, particularly in applications where environmental and human exposure risks are low.

Since the contact layer 3 is formed without the use of conventional tin, undesirable whisker growth is prevented.

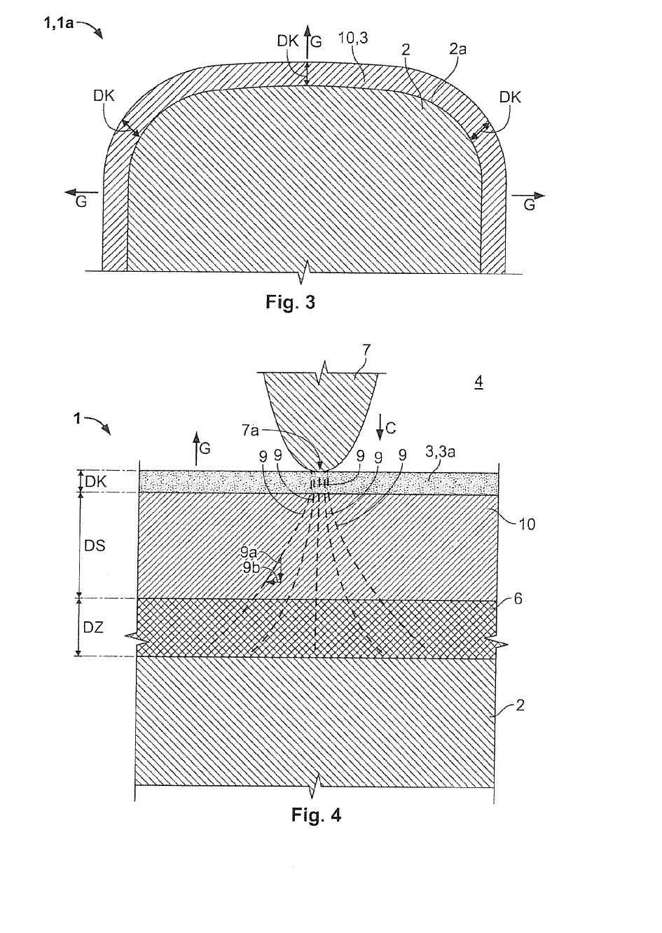

In an embodiment of FIG. 3, a contact layer 10, is shown having the substantially the same physical properties as the contact layer 3. However, a surface 2a of the substrate 2 does not extend linearly, however, but rather extends in a curved manner. The contact layer 10,3 is positioned on an outer facing surface thereof, surrounding the substrate 2. The contact layer 10,3 has, in a growth direction G, a thickness DK which remains constant. The contact element 1,1 a may be, for instance, a pin-like contact element 1 a which contacts a flat surface on a corresponding, complimentary contact (not shown). Such a contact layer 3 may, for example, be produced by an immersion coating method known to those of ordinary skill in the art.

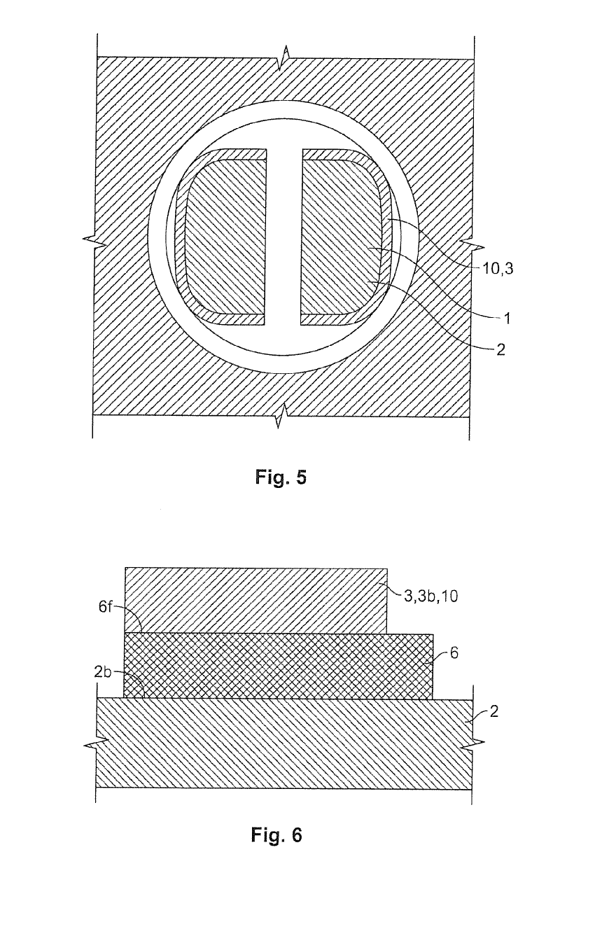

In an embodiment of FIG. 4, the contact layer 10 differs from the contact layer 3, instead having an outer facing surface covered by a separate outer contact layer 3a. The intermediate layer 6 may be positioned between the contact layer 10 and the substrate 2. The contact layer 3 is applied to the contact layer 10 in the growth direction G, and may serve to reduce the transition resistance. The contact layer 3 may serve to prevent soldering or welding of the contact layer 10 to the corresponding contact element 7. Furthermore, the separate contact layer 3a may also prevent a chemical reaction of the contact layer 10 with the corresponding contact element 7 or the environment 4, such as oxidation in the air.

The corresponding contact element 7 presses in a contact direction C on the contact element 1 so that the layer system 5 is under mechanical pressure 9 extending from a tip 7a of the corresponding contact element 7. In the vicinity of the tip 7a, the mechanical pressure 9 includes a first pressure component 9a extending parallel with the contact direction C, and a second pressure component 9b extending perpendicular to the contact direction C and parallel with the layers 3,6,10. The greater the distance from the tip 7a, the greater the second pressure component 9b becomes. The mechanical pressure 9 normally increases the tendency to form tin whiskers, which grow, for example, in a growth direction G from a contact layer 10. However, the whisker growth does not occur from the contact layer 10, since the contact layer 10 contains bismuth and was produced in a tin-free manner.

In an embodiment, the contact element 1 includes an additional separate contact layer 3a to further prevent such growth of whiskers. The contact layer 3a may optionally contain bismuth.

The thickness DZ of the intermediate layer 6, the thickness DS of the contact layer 10 and the thickness DK of the contact layer 3 can be varied depending upon the respective application. In particular, individual thicknesses may be smaller or larger than each of the other thicknesses.

In an embodiment, only a single separate contact layer 3a is present. However, in other embodiments, other layers in the growth direction G towards the contact layer 10 may also be present.

In an embodiment of FIG. 5, the contact layer 10,3 extends around a substrate 2. A forked pin contact 1b, serving as an exemplary contact element 1, is positioned in a corresponding contact element 7, which is shown having a coated contact receiving space. With a convention contact element having tin-containing contact layers, metal whiskers would grow from the contact layer 3 over time, which can break off and/or cause electrical short-circuits. In the contact layer 10,3 whisker formation does not occur since bismuth has replaced conventional tin.

In an embodiment of FIG. 6, the contact layer 3b extends over only a substrate portion 2b of the substrate 2 and over an intermediate portion 6f of the intermediate layer 6. Such a spatial selection may, for example, be achieved by covering the substrate 2 through a galvanic production process to from the contact layer 10 or the intermediate layer 6. A removal of undesired portions 2b,6f of layers 2,6 after the galvanic production process, for instance, by mechanical processing or by means of etching, also leads to such a configuration.

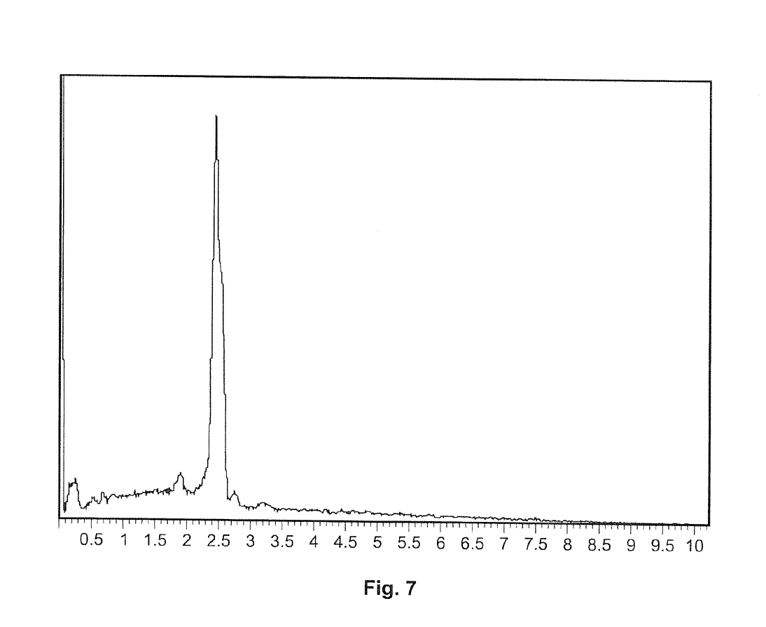

FIG. 7 shows the EDX spectrum (energy-dispersive X-ray spectroscopy) of a galvanically produced sample. The substrate 2 is a copper alloy. The bismuth layer was applied with an additive-free bismuth electrolyte directly to the copper substrate 2 without an intermediate layer.

What is claimed is:

1. A contact layer for an electrical contact, comprising bismuth and being tin-free.

2. The contact layer of claim 1, wherein the bismuth is 10% by weight.

3. The contact layer of claim 1, wherein the bismuth is 50% or more by weight.

4. The contact layer of claim 1, wherein the bismuth is 90% or more by weight.

5. The contact layer of claim 1, wherein the bismuth is substantially pure.

6. The contact layer of claim 1, wherein the composition further comprises lead, zinc, indium, antimony, copper, nickel, silver, gold, palladium, ruthenium, are any combination thereof.

7. The contact layer of claim 1, wherein bismuth is the principle component.

8. The contact layer of claim 1, wherein the composition is positioned directly on a copper substrate.

9. The contact layer of claim 1, wherein the contact layer is positioned directly on a nickel-coated, copper substrate.

10. A method for producing a contact layer, comprising the steps of:
electroplating a layer of bismuth that is tin-free.

11. The method for producing a contact layer of claim 10, wherein the layer of bismuth is electroplated directly to a copper layer.

12. The method for producing a contact layer of claim 10, wherein the layer of bismuth is electroplated directly to a nickel layer disposed over the copper layer.

13. The method for producing a contact layer of claim 10, wherein the bismuth layer is a contact layer electroplated along an insertion region of a plug type connector contact.

14. The method for producing a contact layer of claim 10, wherein the bismuth layer is a contact layer electroplated along a connection region of a plug type connector contact.

15. The method for producing a contact layer of claim 10, wherein the bismuth layer is a contact layer electroplated along a pressing region of a plug type connector contact.
